(19) United States
(12) Patent Application Publication
(10) Pub. No.: US 2026/0131516 A1
(43) Pub. Date: May 14, 2026

(54) CASTING DEVICE

(71) Applicant: BRÜCKNER MASCHINENBAU GmbH, Siegsdorf (DE)

(72) Inventors: Anton EDFELDER, Unterwössen (DE); Anthimos GIAPOULIS, Traunstein (DE)

(21) Appl. No.: 19/381,991

(22) Filed: Nov. 6, 2025

(30) Foreign Application Priority Data
Nov. 8, 2024 (DE) 10 2024 132 661.1

(51) Int. Cl. B29C 48/88; B29C 48/00; B29C 48/08

(52) U.S. Cl. CPC B29C 48/914; B29C 48/0018; B29C 48/08; B29C 48/919

(57) ABSTRACT

A casting device and a machine for producing a film are disclosed including a chill roll, a take-off roll and a water bath. The chill roll is configured to cool a plastic melt extruded onto its surface in order to generate a film F. The take-off roll is arranged downstream of the chill roll and configured to detach the film F from the chill roll. The chill roll is arranged at least partially within the water bath so that the point P at which the film is detached from the chill roll is above the water line of the water bath. The chill roll has a roll width B_{K} and the take-off roll has a roll width B_{T}, the roll width B_{T} of the take-off roll being smaller than the roll width B_{K} of the chill roll.

### CROSS REFERENCE TO RELATED APPLICATION

This application claims priority to German Patent Application Number DE 10 2024 132 661.1, filed Nov. 8, 2024, the entire contents of which is hereby incorporated by reference.

### BACKGROUND

The disclosure relates to a casting device and a machine for producing a film, comprising a corresponding casting device.

In the production of thin plastic films, a plastic melt is first extruded and applied to a chill roll, where it cools and at least partially solidifies (cast film). In order to be able to cool the extruded film or cast film and then feed it to a stretching machine, the chill roll is typically arranged so that it is largely submerged in water. The water bath results in homogeneous and rapid cooling.

In order to detach the cast film from the chill roll, what is referred to as a take-off roll is typically provided. The take-off roll is arranged downstream of the chill roll and configured to detach the film from the chill roll. The point at which the cast film is detached from the chill roll is usually above the water line. The detached film can then be passed through a further water bath and, in particular, fed to a stretching machine, such as a longitudinal and/or transverse stretching machine or a simultaneous stretching machine.

If the point at which the cast film is detached from the chill roll is above the water line, conventional casting devices can largely ensure that the centre of the chill roll, which is covered by the cast film, remains dry. This is necessary since water which gets onto the surface of the chill roll would settle between the chill roll and the newly applied plastic melt. This impairs the film quality and can also lead to film cracks during the subsequent stretching method.

The hot plastic melt would also cause the water between the melt or film and the chill roll to evaporate. The resulting vapour bubbles can damage or even destroy the film.

A general trend in plastic film production is increasing the production speed. This means that the surface speed of the chill roll and the take-off roll must also be increased. This can be achieved through a higher angular speed and/or larger roll diameters.

Current film production machines have a chill roll speed of up to 120 m/min. After longitudinal stretching of the cast film, approximately 500 to 600 metres of film can therefore be produced per minute.

At higher production speeds, for example 700 metres of film per minute, the chill roll speed is already approximately 140 to 150 m/min. A further increase in production speed (e.g. >800 m/min) leads to a corresponding increase in the chill roll speed.

It has been shown that, with conventional casting devices, the chill rolls and take-off rolls already carry significant amounts of water at chill roll speeds >120 m/min. This carrying of water leads to significant formation of splash water. The formation of splash water is so strong that the splash water hits, among other things, the surface of the chill roll and, as described above, impairs the film quality.

### SUMMARY

There is provided an improved casting device and machine for producing films which delivers good film quality even at high production speeds (film output>600 m/min or chill roll speed>120 m/min).

This is achieved by a casting device and by the machine for producing a film according to the claims. Further aspects of the disclosure are described in the following description.

In particular, this is achieved by a casting device for producing plastic films. The casting device comprises at least one chill roll, one take-off roll and one water bath.

The chill roll is configured to cool a plastic melt extruded onto its surface in order to generate a film. The take-off roll is arranged downstream of the chill roll in the film running direction A and configured to detach the film from the chill roll. The chill roll is arranged at least partially in the water bath. The plastic melt extruded onto the chill roll is therefore guided through the water bath with the chill roll and cooled in the process. The chill roll can also be arranged so that a point at which the film detaches from the chill roll is above the water line of the water bath. It is also possible for the point at which the film detaches from the chill roll to be level with or below the water line of the water bath.

If the point at which the film detaches from the chill roll is above the water line of the water bath, water can be prevented from flowing between the chill roll and the film.

The chill roll has a roll width B_{K} and the take-off roll has a roll width B_{T}. The roll width B_{T} of the take-off roll is smaller than the roll width B_{K} of the chill roll. The following relationship therefore applies:

$${B}_{K} > {B}_{T}$$

The roll width indicates here the width (measured in the axial direction of the roll) of the casing surface of the roll on which the melt, or the film, is guided. Axle stubs or other parts of the roll, which serve, for example, as bearings, have no influence on the roll width.

The take-off roll, which is narrower than the chill roll, can significantly reduce the formation of splash water because the reduced width means that less water is carried from the water bath by the take-off roll. This results in fewer splashes. This allows high production speeds to be achieved in film production without jeopardizing film quality due to water splashes.

In one aspect of the disclosure, the casting device further comprises an extrusion nozzle which is configured to extrude the plastic melt onto the surface of the chill roll with an extrusion width B_{S}. The extrusion width B_{S} dictates the minimum width of the chill roll. For example, the width of the chill roll B_{K} is in the range from 100% to 120% of the extrusion width B_{S}, or in the range from 105% to 115% of the extrusion width B_{S}, or in the range from 108% to 112% of the extrusion width B_{S}.

However, the roll width B_{T} of the take-off roll can be reduced compared to the extrusion width B_{S}. This is because the extrusion and subsequent cooling of the plastic melt results in what is referred to as neck-in.

The neck-in refers to the difference between the extrusion width B_{S} and the film width B_{F} when detaching from the chill roll. A constant neck-in typically occurs when there are constant material and process parameters.

The neck-in is influenced by various factors, including material properties, the pull-off speed (speed of the chill roll), the processing temperature and the speed of the extrusion process. In particular, the pull-off ratio and the distance between the extrusion nozzle and the chill roll are also crucial for the neck-in.

The following examples of neck-in are given for some common materials used in film production. The actual neck-in then results from the process parameters.

| | |
|---|---|
| LDPE (Low-Density Polyethylene): | 5-20% of the extrusion width |
| HDPE (High-Density Polyethylene: | 5-20% of the extrusion width |
| LDPE (Linear Low-Density Polyethylene): | 5-15% of the extrusion width |
| PP (Polypropylene): | 5-25% of the extrusion width |
| PET (Polyethylene Terephthalate): | 5-20% of the extrusion width |
| PVC (Polyvinyl Chloride): | 5-10% of the extrusion width |
| PS (Polystyrene): | 5-20% of the extrusion width |
| PA (Polyamide): | 5-15% of the extrusion width |
| EVA (Ethylene Vinyl Acetate): | 15-20% of the extrusion width |

The theoretical film width B_{F} is therefore calculated as follows:

$${B}_{F} = {B}_{S} - Neck - In$$

In addition to the material, neck-in is influenced, inter alia, by the melt viscosity and the processing temperature. The lower the viscosity of the material (or the higher the processing temperature), the higher the neck-in.

In general, materials with low melt viscosity, such as LDPE, EVA or polystyrene, have higher neck-in values, whilst materials with higher viscosity, such as PET, PA or PVC, have lower values.

The neck-in phenomenon can be taken into account when selecting the take-off roll width B_{T}. The roll width B_{T} can therefore be in the range from 70% to 105% of the extrusion width, or in the range from 75% to 100% of the extrusion width, or in the range from 80% to 95% of the extrusion width. In particular, the take-off roll width can be adapted to the film width B_{F} so that the take-off roll has no or only a very small number of roll edges which are not covered by the film. This can significantly reduce the entrainment of water and therefore the formation of splash water.

The casting device according to the disclosure enables high production speeds. In particular, the chill roll can be configured to rotate at a surface speed of at least 120 m/min, or at least 130 m/min, or at least 140 m/min, or at least 150 m/min, or at least 160 m/min.

In a further aspect, the take-off roll can be coated with a polymer material, wherein the polymer material comprises rubber and/or at least one polyhalogenolefin, in particular polytetrafluoroethylene.

In particular, the polymer material can be hydrophobic. This further reduces the entrainment of water. A surface is considered to be hydrophobic if it has a lower surface tension than water (72 mN/m) or if the contact angle is more than 90° relative to water.

In a further aspect, the take-off roll is height-adjustable. The height adjustment can determine whether and how deep the take-off roll submerges into the water bath. This allows the amount of water entrained to be controlled. The less the take-off roll is submerged into the water bath, the smaller the amount of water entrained.

In one aspect, the take-off roll is arranged entirely above the water line of the water bath. It therefore does not submerge into the water bath. This prevents the take-off roll from entraining any water.

The take-off roll can also be an internally cooled take-off roll. This means that the take-off roll comprises cooling means within it. For example, cooling water or another cooling fluid can be passed through the take-off roll, in particular through a casing of the take-off roll, to cool it. This can prevent overheating of the roll surface, especially if the take-off roll is barely submerged into the water bath or not submerged at all.

The take-off roll can also be an actively driven take-off roll. For this purpose, a drive can be assigned to the take-off roll. This drive can be controlled or regulated so that the surface speed of the take-off roll corresponds to the surface speed of the chill roll. This prevents the film from being stretched or compressed when it is detached from the chill roll.

The casting device can also comprise a water removal device. The water removal device is preferably assigned to the chill roll here and arranged after the take-off roll in the circumferential direction of the chill roll. The water removal device ensures that the surface of the chill roll is free of water before the plastic melt is re-extruded onto its surface.

The water removal device can comprise mechanical water removal elements, such as scrapers, squeegees or squeezing rolls.

Alternatively or additionally, the water removal device can comprise at least one blow-off nozzle which blows off any water present on the surface of the chill roll. The blow-off nozzle can be designed in the form of an air knife.

The casting device can also comprise at least one water retention element. The water retention element is arranged adjacent to the casing surface of the chill roll and at the front face in relation to the take-off roll.

In particular, at least two water retention elements can be provided. The take-off roll can be arranged between these water retention elements.

The at least one water retention element is arranged in an area adjacent to the casing surface of the chill roll in which the take-off roll is not opposite the casing surface of the chill roll due to the smaller roll width.

In particular, the water retention element can be arranged below the point at which the film is detached.

In one aspect, the water retention element comprises a cover element which is arranged at a distance from the casing surface of the chill roll so that a gap is formed between the casing surface of the chill roll and the cover element. The width of the gap can, for example, be in the range from 0.1 mm to 10 mm, or in the range from 0.5 mm to 5 mm, or in the range from 1 mm to 3 mm. The cover element prevents water splashes, which may be caused, for example, by water entrained by the chill roll, from reaching the free surface of the chill roll (i.e. the surface not covered by a film).

The at least one water retention element (in particular the cover element) can also protrude beyond a front face of the chill roll. This allows water splashes to be retained even more effectively. Optionally, the water retention element (in particular the cover element) also overlaps a front face of the chill roll. This means that not only the casing surface is covered, but also part of the front face so that water splashes can be effectively retained here as well.

In a further aspect, the at least one water retention element is in contact with the casing surface of the chill roll. Contact can occur above or below the water line. This contact can reduce the amount of water entrained, which can also reduce water splashing. Contact can occur, for example, via an elastic element, such as a rubber lip, or a squeezing roll. Accordingly, the water retention element can comprise an elastic element, such as a rubber lip, a squeezing roll, or the like.

In the case of one or more squeezing rolls, these can be mounted on the same axis as the take-off roll or be formed integrally with the squeezing roll. In the integral design, the casing surface of the take-off roll on which the film is guided is offset from the squeezing roll, for example by a circumferential recess and/or by different coatings.

The at least one water retention element can also comprise a blow-off nozzle, in particular an air knife. The blow-off nozzle is configured to blow off entrained water at least from an edge area of the chill roll.

This is also achieved by a machine for producing a film, the machine comprising at least one extruder and/or one reactor and the abovementioned casting device. The extruder is configured to deliver a plastic melt (e.g. PE, PP, PET, etc.) to the extrusion nozzle so that the plastic melt is extruded onto the chill roll.

A reactor is configured to generate the plastic melt by means of polymerization. For this purpose, the monomers (and optionally additives such as catalysts) are mixed and polymerized in the reactor. The resulting polymerized plastic melt can then be delivered to the extrusion nozzle and extruded onto the chill roll, eliminating the need for an additional extruder.

The machine can also comprise a stretching machine which is arranged downstream of the casting device and configured to stretch the film in the longitudinal direction and/or transverse direction. Stretching in the longitudinal and transverse directions can occur simultaneously or sequentially.

### BRIEF DESCRIPTION OF THE DRAWINGS

Additional features and advantages of the disclosure are found in the following description as well as the attached drawings to which reference is made. In the drawings:

FIG. 1 shows a schematic representation of a machine for producing a film;

FIG. 2 shows a schematic representation of a casting device;

FIG. 3 shows a further view of the casting device; and

FIG. 4 shows a further casting device.

### DETAILED DESCRIPTION

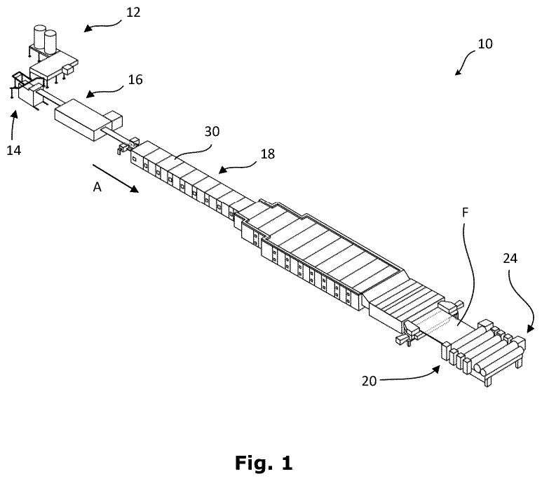

FIG. 1 shows a highly schematic illustration of a machine 10 for producing a film A which comprises several different devices and machines.

In the example shown, the machine 10 has an extrusion machine 12, a casting device 14, at least one longitudinal stretching machine 16 (MDO, “Machine Direction Orienter”), a transverse stretching machine 18 (TDO, “Transverse Direction Orienter”), an optional treatment device 20 and a winding device 24.

The optional treatment device 20 can be a separate assembly or, for example, integrated into the winding device 24.

The extrusion machine 12 has at least one extruder 120 and is configured to generate a melt from at least one starting product.

The starting product can comprise, for example, plastic granulate, plastic powder, plastic recyclate, additives and/or the like.

The at least one extruder can be a single-screw extruder, a cascade extruder, a twin-screw extruder, a planetary roller extruder and/or the like. It is also conceivable for other mixing and processing units, such as a co-kneader, to be used.

By means of an extrusion nozzle, such as a slot die 126, the generated melt is applied to a chill roll 142 of the casting device 14, thereby generating a film F. The chill roll 142 can, for example, rotate at a speed (measured on the chill roll surface) of at least 120 m/min, or at least 130 m/min, or at least 140 m/min, or at least 150 m/min, or at least 160 m/min.

It is also possible to generate the plastic melt by means of polymerization. For this purpose, the monomers (and optionally additives such as catalysts) are mixed and polymerized in a reactor and/or an extruder. The resulting polymerized plastic melt can then be applied directly onto the chill roll 142 of the casting device 14 via the extrusion nozzle 126, thereby generating a film F.

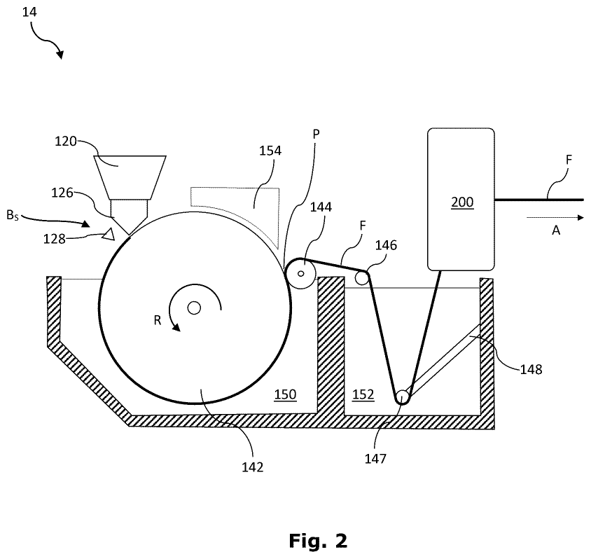

Provision is optionally made for what is referred to as an application device 128 (see FIG. 2) with which the melt emerging from the extrusion nozzle can be precisely applied to the chill roll and fixed there. The application device 128 comprises, for example, an air knife and/or what is referred to as a pinning electrode. The precise application leads to even cooling and a high-quality film surface.

The extruded film F can have one or more layers. In the case of a multi-layer film, it is conceivable for one extruder to generate a number or all of the layers, or for an extruder to be provided for each layer.

After passing through the casting device 14, the film F, in the example shown here, is fed to a longitudinal stretching machine 16. In this machine, the film is stretched and thus elongated in a first direction, i.e. in the draw-off direction A. After passing through the longitudinal stretching machine, the film (depending on the longitudinal stretch ratio, which is typically in the range from 3 to 5) can, for example, have a film speed of at least 600 m/min, or at least 700 m/min, or at least 800 m/min.

The subsequent transverse stretching machine 18, as described, for example, in DE 10 2021 128 332 A1, has an oven 30 with various zones for controlling the temperature of the film F along the usual direction of movement or withdrawal A of the machine 10. In the oven 30, the film F is stretched in the transverse direction, i.e. transversely to the take-off direction A, in a manner known per se. It is therefore possible to produce a mono- or biaxially oriented film.

Instead of two separate stretching machines 16, 18 for longitudinal and transverse stretching, a simultaneous stretching machine can also be used. In this, the film is stretched simultaneously in the longitudinal and transverse directions.

The treatment device 20 is, for example, a device for activating the surface of the film F by a corona treatment, for example to achieve better metal adhesion.

The winding device 24 is used to wind up the generated film F and is the last device in the direction of withdrawal A. It has a winding core onto which the film F is wound.

FIG. 2 shows an enlarged, schematic view of the casting device 14.

The casting device 14 shown here comprises the slot die 126, the chill roll 142 and an application device 128.

The slot die 126 is arranged above the chill roll 142 and is designed to continuously apply the plastic melt to the chill roll 142 which forms the film F. The plastic melt is applied with an extrusion width B_{S}. The plastic used is, in particular, polyethylene (PE), polypropylene (PP), polyethylene terephthalate (PET) and/or the like. It is also possible to combine different plastics. In particular, a film can have different plastic layers and/or different plastics can be co-extruded in one layer.

The film F is then evenly applied to the chill roll 142 by means of the application device 128. The chill roll 142 rotates anticlockwise here (rotation direction R) in the view according to FIG. 2. In the exemplary embodiment shown, after approximately three-quarters of a rotation of the chill roll 142, the film F generated in this way is finally detached from the chill roll 142, cooled and fed to a stretching machine 16, 18.

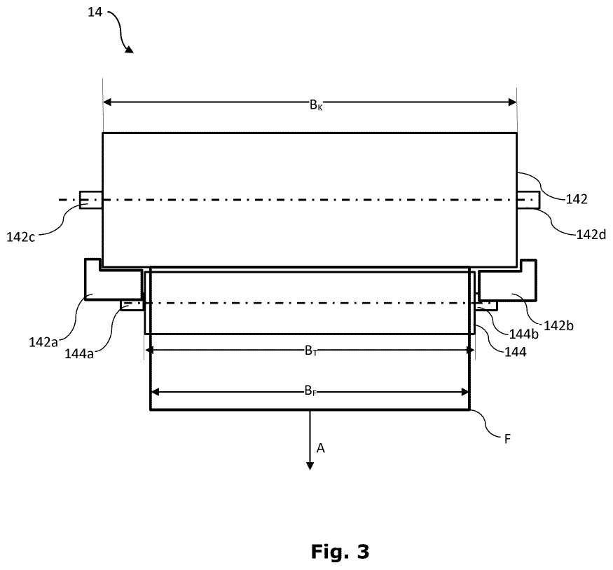

During cooling of the plastic melt, depending on the material used, a process referred to as neck-in occurs. The width of the film is therefore reduced by cooling from B_{S} to the film width B_{F} (see FIG. 3).

To detach the film F from the chill roll 142, the casting device 14 comprises a take-off roll 144 which has a plurality of deflection rolls 146, 147 arranged downstream. The deflection roll 147 is arranged on a tensioning element 148. The tensioning element is designed here as a pivotable lever. The tension of the film F can be set or regulated via the angular position of the lever.

As shown, the chill roll 142 can be arranged in a first water bath to cool the extruded film F and the chill roll 142. After the take-off roll 144, which serves to detach the extruded film F from the chill roll 142, the film F can be guided through a further water bath 152 by means of the deflection rolls 146, 147 in order to achieve further cooling.

The take-off roll 144 can be arranged partially in the water bath 150, as in the exemplary embodiment shown, the detachment point P being located above the water line.

It is also possible to arrange the take-off roll 144 so that it is outside the water bath 150, i.e. entirely above the water line. In this alternative embodiment, the take-off roll 144 is preferably cooled. For this purpose, cooling water or another cooling fluid can be passed through the take-off roll, in particular through a casing of the roll.

It is also possible for the take-off roll 144 to be an actively driven roll. For this purpose, a drive can be assigned to the take-off roll 144 (not shown).

It is also possible for the take-off roll 144 to be configured to be height-adjustable. This allows the take-off roll 144 to be submerged into the water bath 150 to different depths (or not at all).

Before the film F is fed to a longitudinal, transverse or simultaneous stretching machine 16, 18, it typically passes through a water removal device 200. In this water removal device 200, any water adhering to the film can be blown off, mechanically wiped off and/or removed in some other way.

The casting device 14 can also comprise a water removal device 154. As shown in FIG. 2, the water removal device 154 is assigned to the chill roll 142 and arranged in the circumferential direction R of the chill roll 142 after the take-off roll 144. The water removal device 154 ensures that the surface of the chill roll is free of water before plastic melt is re-extruded onto its surface.

FIG. 3 shows a schematic top view of the casting device 14. As shown, the chill roll 142 has a roll width B_{K} and the take-off roll 144 has a smaller roll width B_{T}. In the example shown, the roll width B_{T} of the take-off roll is in the range from 70% to 100% of the extrusion width B_{S} and therefore roughly corresponds to the film width B_{F}.

The chill roll 142 optionally has axle stubs 142c, 142d which serve to support the chill roll. Accordingly, the take-off roll 144 can have axle stubs 144a, 144b which serve to support the take-off roll. These axle stubs have no influence on the roll width B_{K} of the chill roll or the roll width B_{T} of the take-off roll because the roll width specifies the width (measured in the axial direction of the roll) of the casing surface of the roll on which the melt, or the film, is guided.

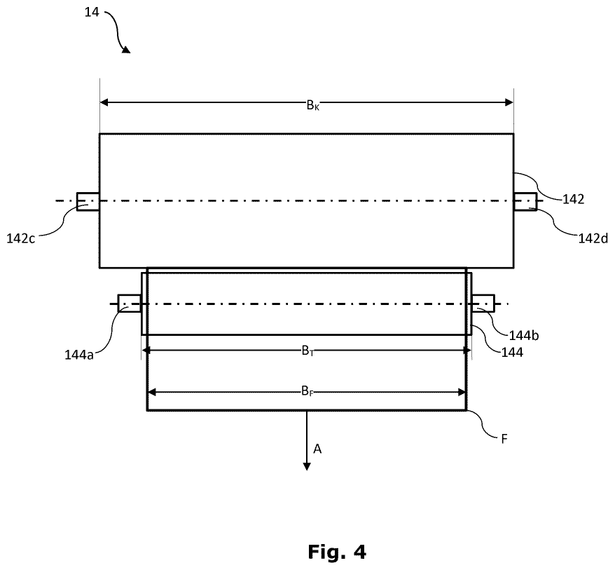

In the exemplary embodiment shown, water retention elements 142a, 142b are arranged to the left and right of the take-off roll. The water retention elements 142a, 142b are optional, as the embodiment shown in FIG. 4 illustrates.

The water retention element 142a, which comprises a cover element or is designed as a cover element, is arranged adjacent to the casing surface of the chill roll 142 and on the left at the front face in relation to the take-off roll 144. The water retention element 142b, which comprises a cover element or is designed as a cover element, is arranged adjacent to the casing surface of the chill roll 142 and on the right at the front face in relation to the take-off roll 144. The water retention elements 142a, 142b prevent water splashes from being able to reach the exposed surface of the chill roll.

As also shown, the water retention elements 142a, 142b extend to the left and right over the respective front face of the chill roll 142 and at least partially overlap the respective front face of the chill roll 142.

FIG. 4 shows a schematic top view of a further casting device 14. This corresponds to the casting device from FIG. 3. However, no water retention elements are provided.

1. A casting device for producing plastic films, comprising:
a chill roll, a take-off roll and a water bath,
wherein the chill roll is configured to cool a plastic melt extruded onto its surface in order to generate a film,
wherein the take-off roll is arranged downstream of the chill roll and configured to detach the film from the chill roll, and wherein
the chill roll is arranged at least partially in the water bath,
wherein the chill roll has a roll width and the take-off roll has a roll width, B_{T}, and
wherein the roll width, B_{T}, of the take-off roll is smaller than the roll width of the chill roll.

2. The casting device according to claim 1, wherein the casting device comprises an extrusion nozzle which is configured to extrude the plastic melt onto the surface of the chill roll with an extrusion width, B_{S}, and
wherein the roll width, B_{T}, of the take-off roll is in the range from 70% to 105% of the extrusion width, B_{S}, or in the range from 75% to 100% of the extrusion width, B_{S}, or in the range from 80% to 95% of the extrusion width B_{S}.

3. The casting device according to claim 1, wherein the chill roll is configured to rotate with a surface speed of at least 120 m/min, or at least 130 m/min, or at least 140 m/min, or at least 150 m/min or at least 160 m/min.

4. The casting device according to claim 1, wherein the take-off roll is coated with a polymer material, wherein the polymer material comprises at least one of rubber or at least one polyhalogenolefin, or polytetrafluoroethylene.

5. The casting device according to claim 1, wherein the take-off roll is set up height-adjustable.

6. The casting device according to claim 1, wherein the take-off roll is arranged entirely above the water line of the water bath.

7. The casting device according to claim 1, wherein a point at which the film is detached from the chill roll is above the water line of the water bath, level with the water line of the water bath, or below the water line of the water bath.

8. The casting device according to claim 1, wherein the take-off roll is an actively driven take-off roll.

9. The casting device according to claim 1, wherein the casting device further comprises a water removal device, wherein the water removal device is assigned to the chill roll and arranged in the circumferential direction of the chill roll after the take-off roll.

10. The casting device according to claim 1, wherein the casting device comprises at least one water retention element, wherein the water retention element is arranged adjacent to the casing surface of the chill roll and at the front face in relation to the take-off roll.

11. The casting device according to claim 1, wherein the at least one water retention element protrudes beyond a front face of the chill roll.

12. The casting device according to claim 11, wherein the at least one water retention element at least partially overlaps the front face of the chill roll.

13. The casting device according to claim 1, wherein the at least one water retention element comprises a blow-off nozzle which is configured to blow off entrained water from an edge area of the chill roll.

14. A machine for producing a film, wherein the machine comprises at least one of an extruder or a reactor, and the casting device according to claim 2, and wherein the extruder or the reactor configured up to deliver a plastic melt to the extrusion nozzle.

15. The machine for producing a film according to claim 14, wherein the machine further comprises a stretching machine which is arranged downstream of the casting device and which is configured to stretch the film at least in a longitudinal direction or in a transverse direction.
